(19) United States
(12) Patent Application Publication
(10) Pub. No.: US 2011/0018616 A1
(43) Pub. Date: Jan. 27, 2011

(54) CHARGE PUMP CIRCUIT

(75) Inventors: Ping Chung Li, Shatin (CN); Cong Ke Li, Shatin (CN)

Correspondence Address: MERCHANT & GOULD PC, P.O. BOX 2903, MINNEAPOLIS, MN, 55402-0903, US

(73) Assignee: Kontel Data System Limited, Shatin N.T. (CN)

(21) Appl. No.: 12/507,583

(22) Filed: Jul. 22, 2009

(51) Int. Cl. G05F 3/02

(52) U.S. Cl. 327/536

(57) ABSTRACT

A charge pump circuit for biasing a capacitive transducer. The charge pump circuit includes a plurality of parallel arranged transistor-capacitor units each having a bipolar junction transistor with a collector terminal connected to a base terminal and an emitter terminal connected to a capacitor. The charge pump circuit also includes drive circuitry for driving the transistor-capacitor units at a predetermined rate, as well as load current circuitry connected to a last transistor-capacitor unit and configured to determine a load current through the transistor-capacitor units in order to establish a controllable voltage drop across the transistor-capacitor units. Also included is supply circuitry configured to supply the transistor-capacitor units and drive circuitry, the supply circuitry configured to bias a base-emitter voltage of the transistor-capacitor units proportional to the load current so that an output voltage of the charge pump is substantially independent of temperature fluctuations.

### BACKGROUND OF THE INVENTION

This invention relates to a charge pump circuit for generating a supply voltage for application in biasing capacitive sensors, particularly micro-electromechanical systems (MEMS) type microphone or pressure sensors.

### DESCRIPTION OF THE PRIOR ART

Reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

A MEMS microphone or pressure sensor is typically a micro-electromechanical structure deposited on a silicon foundation according to integrated circuit manufacturing techniques. Such sensors can be used to convert sound pressure or gas/fluid pressure into an equivalent electrical signal. A MEMS microphone sensor is typically a two terminal capacitive device. In one example, such a sensor includes a capacitor whose capacitance is affected by pressure fluctuations on a flexible membrane, forming one plate of the capacitor, with the other plate being fixed to, and electrically insulated from, the silicon substrate.

An example of a MEMS microphone circuit is shown in FIG. 1. To convert a pressure signal, a constant voltage is applied as a bias voltage across two terminals of the MEMS capacitive sensor 10 having capacitance C_{MEMS}. In this example, there are two bias voltages, namely Vₕᵥ from a charge pump circuit 12, and Vₐₘₚ_{_{—}}_{bias} from a voltage amplifier bias circuit 14. Together, the charge pump 12 and the bias circuit 14 generate a difference bias voltage for the MEMS microphone sensor 10 according to the formula: V_{MEMS}=Vₕᵥ−Vₐₘₚ_{_{—}}_{bias}.

A capacitor represents an infinite resistance to a DC current flow and the amplifier 16 connected to one terminal of the MEMS sensor 10 requires a definite potential to operate correctly. It is therefore necessary to connect a very high ohmic ‘resistor’ or equivalent device 18 having resistance R_{bias} to the input terminal of the amplifier 16 and thence to one terminal of the MEMS sensor, as shown. The high resistance of R_{bias} ensures that charge conservation in the lower terminal of MEMS capacitive sensor 10 takes place.

Any variation in the capacitance of the sensor C_{MEMS} is converted into a voltage variation with the application of the differential bias voltage V_{MEMS} according to the formula:

ΔV=ΔC·V_{MEMS},

where ΔV and ΔC represent the change in voltage at the capacitor/amplifier terminal, and change in sensor capacitance, respectively.

An intrinsic sensitivity Se of the capacitive sensor is defined as the change in output voltage ∂_{Vout} (in dBV) per unit change of pressure P (in Pascal) as:

Se=∂_{Vout}/∂R.

The intrinsic sensitivity is the sensitivity of the sensor 10 with an ideal amplifier attached. The ideal amplifier has a gain of K over the entire frequency spectrum, infinite large input resistance and infinitely small input capacitance.

The extrinsic sensitivity of the capacitive sensor is the sensitivity of the sensor 10 connected to an amplifier with finite input capacitance and extremely high impedance. Conventionally, only the extrinsic sensitivity of a MEMS sensor can be reliably measured.

If it is assumed that the variation in capacitance of the sensor AC is linearly proportional to the pressure P, the following relationship results wherein the sensitivity Se is directly related to the differential bias voltage V_{MEMS}:

Se=V_{MEMS}*∂C/∂P,

and substituting V_{MEMS} in terms of the voltage bias values above yields:

Se=(Vₕᵥ−Vₐₘₚ_{_{—}}_{bias})*∂C/∂P

Accordingly, any inaccuracies in the differential bias voltage Vₕᵥ−Vₐₘₚ_{_{—}}_{bias} lead to variation in the sensitivity of the sensor. It is therefore important that the voltages of both bias circuits are precise and any noise reduced to a minimum to achieve high conversion performance in the sensor system.

As shown by the above equation, a high sensitivity value requires a high bias voltage V_{MEMS}. However, the bias voltage is practically limited by the so-called “pull-in” voltage of the MEMS capacitive sensor 10. Above this pull-in voltage, the flexible plate of the capacitor 10 is attracted and attached to the fixed plate by electrostatic force. The sensor 10 fails to function beyond this point. Precise control of the bias voltage V_{MEMS} is important for the proper operation of the circuit of FIG. 1.

Most known MEMS capacitive microphone or pressure sensors operate with a bias voltage between 8V-15V at a supply voltage of 2V-3.6V. To generate the higher bias voltage, a voltage multiplying circuit or a charge pump is generally used.

Charge pump circuits are known. One example is described in J. F. Dickson, “On-Chip High Voltage Generation in MNOS Integrated Circuits Using an Improved Voltage Multiplier Technique”, IEEE Journal of Solid State Circuits, Vol. 11, No. 3, June 1976. An example of such a charge pump circuit is shown in FIG. 2. In a simple form, a charge pump consists of a connected chain of diode-connected MOS transistors 20 alternately driven by capacitors 22 tied to a two phased clock system 24. The clock phases 24 can be overlapping or non-overlapping.

The output voltage Vₒᵤₜ depends on the number of stages N of capacitor and transistor units 26, the upper and lower voltages of the clock drivers 24 which are tied to the supply voltage V_{dd} and ground, the threshold voltage Vₜₕ of the diode connected MOS transistor, as well as the conducted current of the pump circuit. In a simplified form, the output voltage Vₒᵤₜ is given by:

Vₒᵤₜ=N(V_{dd}−Vₜₕ)+V_{dd}

It has been found that the threshold voltage Vₜₕ and the conduction current have the biggest effect on the output voltage Vₒᵤₜ. The threshold voltage Vₜₕ in an integrated circuit MOS process can vary by as much as +/−0.1V. If an NMOS transistor is used, its threshold is further dependent on the source to bulk voltage. The conducting current in the charge pump causes a voltage drop in the MOS transistor which is dependent on the carrier mobility, the width to length ratio of the transistor and the gate oxide thickness. All of the above mentioned factors can be subject to variations during the IC manufacturing process and temperature changes.

In Shin et al, “A New Charge Pump Without Degradation in Threshold Voltage Due to Body Effect”, IEEE Journal of Solid State Circuits, Vol. 35., No. 8, August 2007, the above-described threshold effect is alleviated through the use of the body of the MOS transistor as an active terminal.

FIG. 3 shows a section of the Dickson charge pump of FIG. 2. Specifically, a portion between an (M−1)^{th}, M^{th} and (M+1)^{th} transistors 20 is schematically represented. The capacitors 22 having capacitance C is shown, with a parasitic capacitor 21 having capacitance Cₚ to ground is also indicated. The parasitic capacitance 21 includes all the parasitic capacitances of the circuit, including the transistor terminals, interconnection lines, etc. The two clock lines of clock system 24 operate between the supply voltage V_{dd} and ground, as shown.

FIG. 4 shows the transistor portion of FIG. 3 during the two respective clock phases. In FIG. 4A, transistors M−1 and M+1 are conducting and M is shown in a non-conducting mode. In this phase, transistor M is not conducting because the voltages on the bottom plate of the capacitors causes V_{A} and V_{c} to be low and V_{B} to be high, thus reverse-biasing the diode-connected transistor M. FIG. 4B shows transistors M−1 and M+1 in a non-conducting mode and M in a conducting mode.

Taking parasitic capacitance Cp into account, the output voltage of the Dickson charge pump becomes:

Vₒᵤₜ=N(V_{dd}*C/(C+Cp)−Vₜₕ)+V_{dd}

A correctional factor C/(C+Cp) is included. The formula is derived by assuming that the voltage supply to the charge pump and the clock drivers are the same and equal to the supply voltage V_{dd}, which is assumed temperature and load independent. However, as described above, the threshold voltage Vₜₕ of the diode connected MOS transistor varies according to many factors, including manufacturing tolerances, temperature, current loading and particularly the location of the relevant transistor in the charge pump. As such, the output voltage Vₒᵤₜ can deviate very much depending on these factors.

The threshold voltage Vₜₕ of each MOS device, when in a conduction state, is dependent on leakage current through the device, as well as a temperature of the device. For example, a current loading due to junction leakage and sensor leakage is usually small at room temperature and can be in the range of 1-10 pA, but this value is highly dependent on manufacturing tolerances. A mere increase from 1 pA to 5 pA leakage, which may not be a significant increase in the loading, can cause a 70 mV change in the threshold voltage Vₜₕ of each of the transistors in the charge pump circuit chain. When there are 10 stages, this corresponds to a change of 0.7V, a very large value when compared to the output Vₒᵤₜ of the charge pump, which may only be 10V.

FIG. 5 shows the node voltages V_{A} and V_{B} and current I_{M} of the M^{th} stage transistor during its conduction phase. It is clear that both node voltages V_{A} and V_{B} and the current I_{M} fluctuate violently in transition. In particular the current, shown in the lowest graph, shows a dramatic change between the start and end of the clock cycle. However, it should be noted that the charge pump output voltage Vₒᵤₜ depends more on the value of current I_{M} and the Vₜₕ drop at the end of the clock cycle.

Normally there is no loading on the Dickson charge pump circuit itself except for the leakage current in the transistors 20 and through the capacitive sensor 10. However since the sensor 10 is typically exposed to the atmosphere, surface adhesion of contaminants and vapor at different temperature can cause the leakage current to vary by two to three orders of magnitude. The corresponding change in threshold voltage Vₜₕ can be several tens of millivolt, as mentioned above. It is difficult in accurately predicting the exact leakage current in this case as it is determined by environmental factors that are not a repeatable factor of the design.

The current invention proposes a possible solution to the above shortcomings.

### SUMMARY OF THE PRESENT INVENTION

According to a first aspect of the invention there is provided a charge pump circuit for biasing a capacitive transducer, said circuit comprising:
a plurality of parallel arranged transistor-capacitor units each having a bipolar junction transistor with a collector terminal connected to a base terminal and an emitter terminal connected to a capacitor;
drive circuitry for driving the transistor-capacitor units at a predetermined rate;
load current circuitry connected to a last transistor-capacitor unit and configured to determine a load current through the transistor-capacitor units in order to establish a controllable voltage drop across the transistor-capacitor units; and
supply circuitry configured to supply the transistor-capacitor units and drive circuitry, the supply circuitry configured to bias a base-emitter voltage of the transistor-capacitor units proportional to the load current so that an output voltage of the charge pump is substantially independent of temperature fluctuations.

Typically, the charge pump circuit includes a controlled impedance circuit connected to an output of the charge pump and configured to filter out switching noise of the drive circuitry.

Typically, the load current circuitry is configured to override a leakage current of the transistor-capacitor units.

Typically, the supply circuitry is configured to supply a voltage which is a sum of a base-emitter voltage V_{be} of each unit and a temperature stable constant voltage to the drive circuitry.

Typically, the drive circuitry includes buffer circuitry for buffering a clock signal determining the predetermined rate.

The invention is now described, by way of example, with reference to the accompanying drawings. The following description is intended to illustrate particular examples of the invention and to permit a person skilled in the art to put those examples of the invention into effect. Accordingly, the following description is not intended to limit the scope of the preceding paragraphs or the claims in any way.

### BRIEF DESCRIPTION OF THE DRAWINGS

An example of the present invention will now be described with reference to the accompanying drawings, in which:—

FIG. 1 shows a schematic example of a MEMS microphone circuit;

FIG. 2 shows a circuit diagram of a prior art Dickson charge pump;

FIG. 3 shows a section of the Dickson charge pump of FIG. 2;

FIG. 4A shows a schematic representation of operation of the Dickson charge pump of FIG. 2 during one clock phase;

FIG. 4B shows a schematic representation of operation of the Dickson charge pump of FIG. 2 during a second clock phase;

FIG. 5 shows a graphical representation of node voltages and current of an M^{th} stage transistor in the Dickson charge pump circuit of FIG. 2 as a function of time;

FIG. 6 shows an example of a charge pump circuit in accordance with the current invention; and

FIG. 7 shows a schematic example of supply circuitry for the charge pump circuit of FIG. 6.

### DETAILED DESCRIPTION OF PREFERRED EXAMPLES

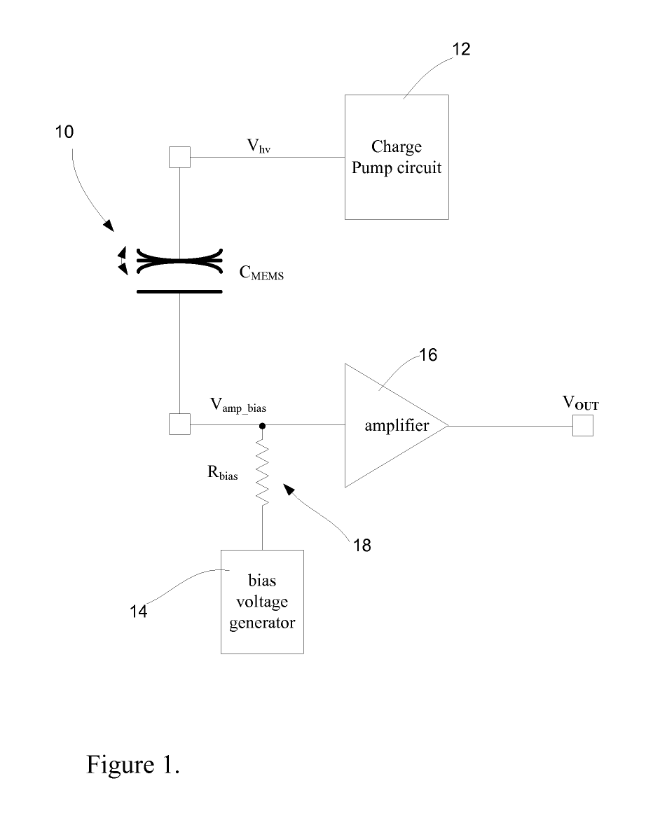

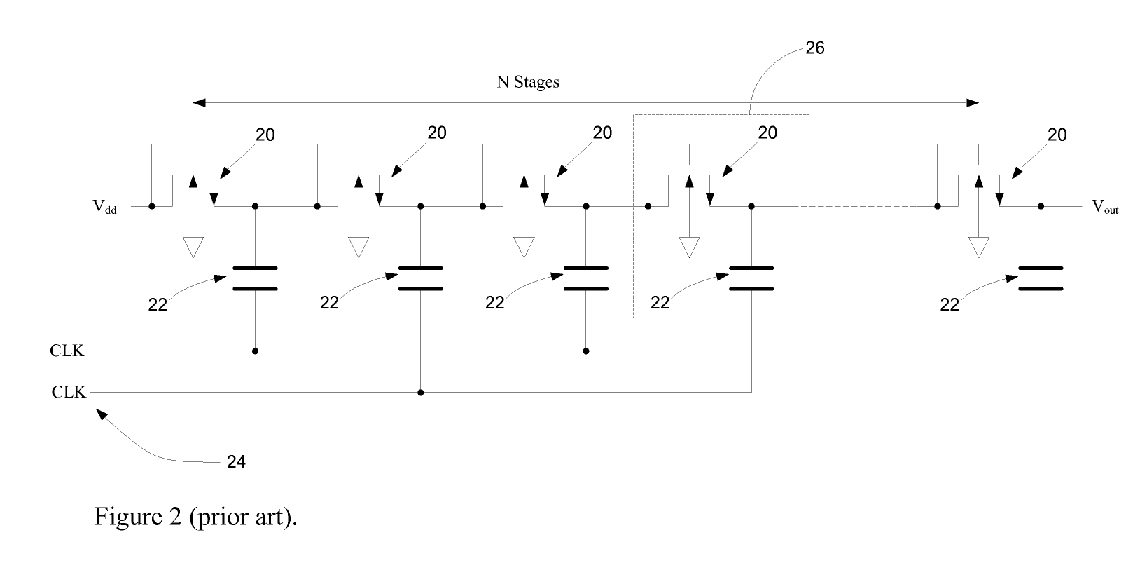

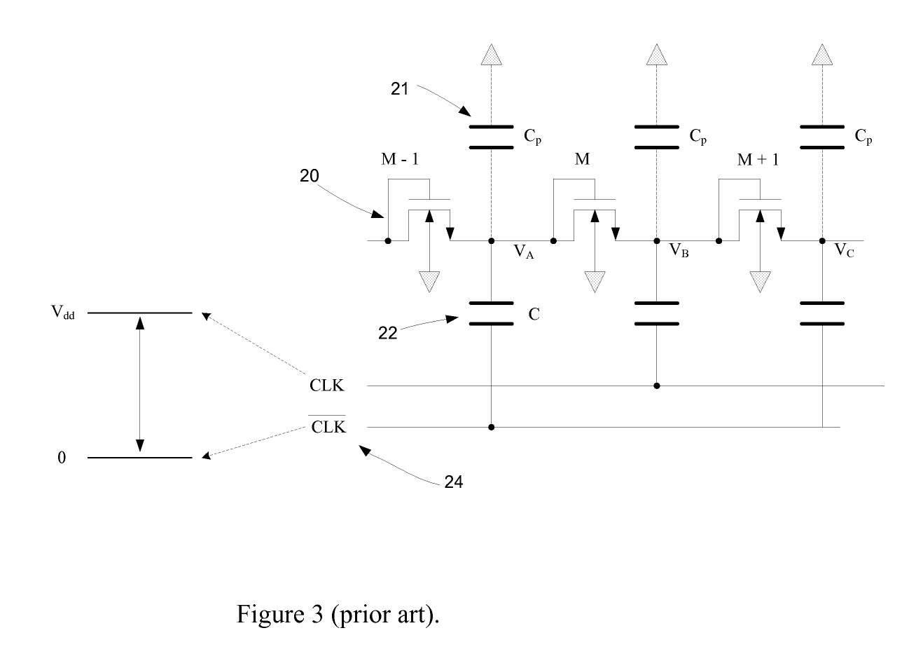

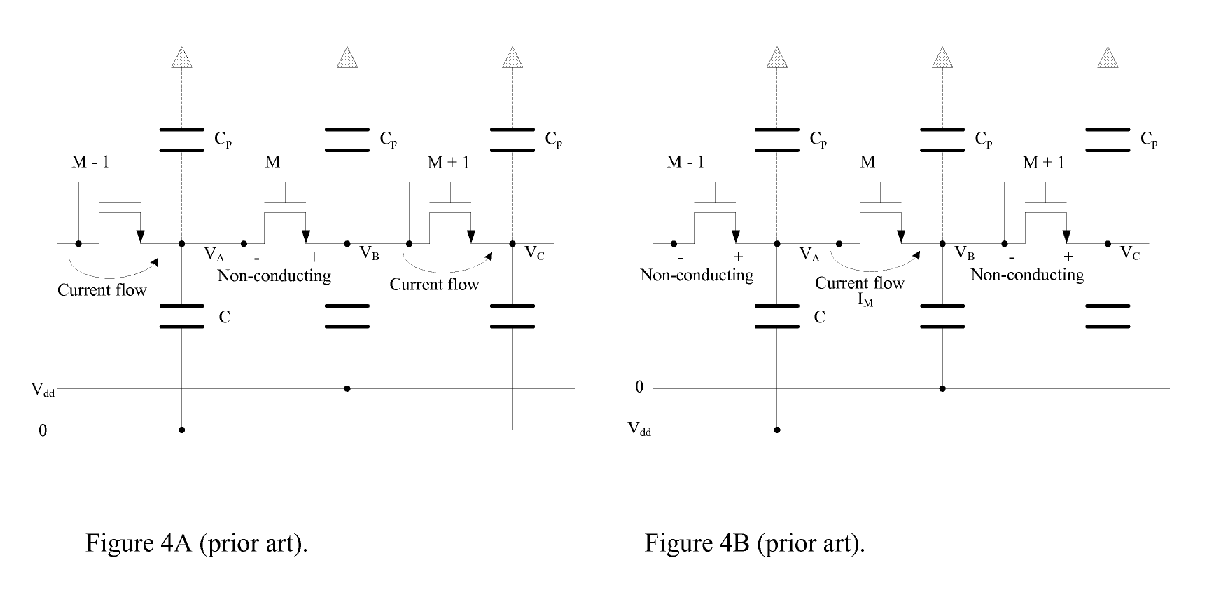

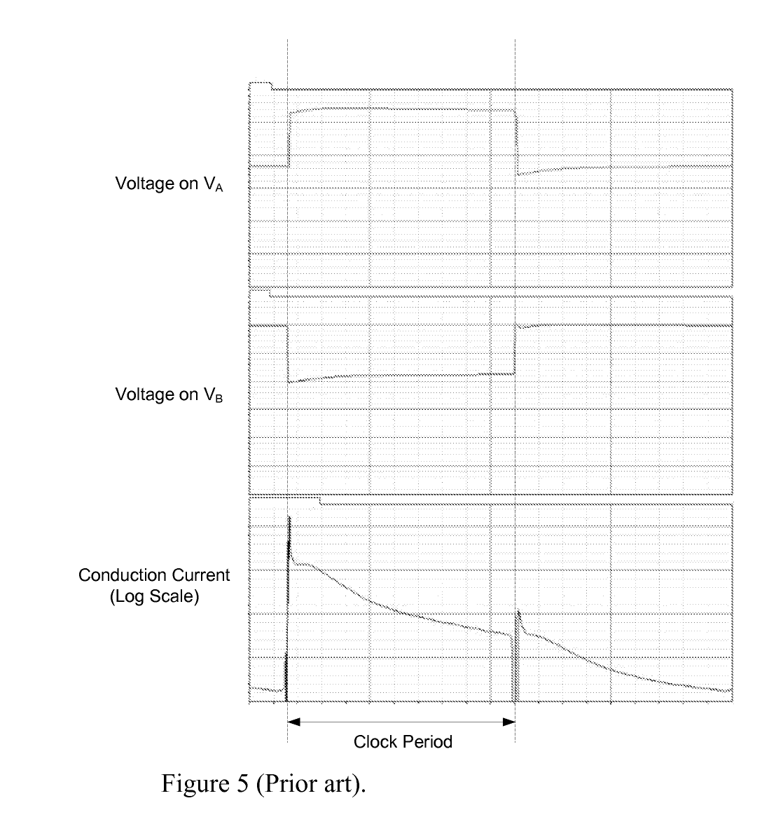

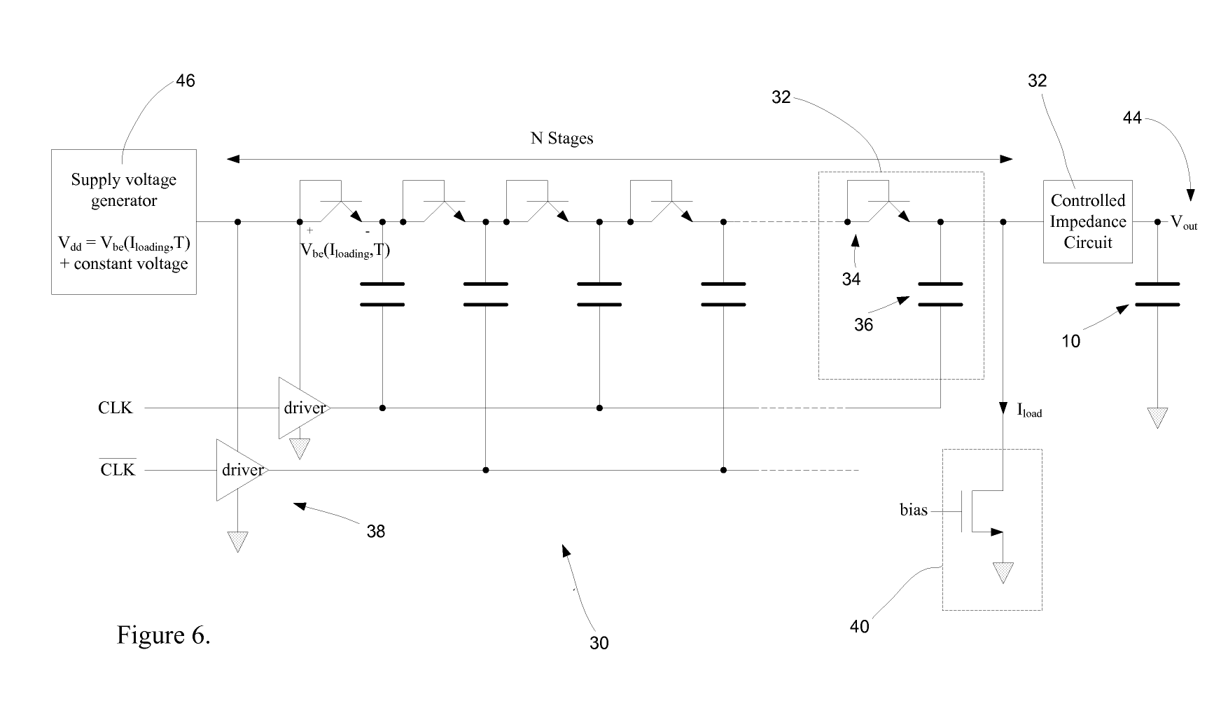

With reference now to FIG. 6 of the drawings, there is shown an example of a charge pump circuit 30. The charge pump circuit 30 is typically used for biasing a capacitive transducer, such as a MEMS microphone. FIG. 1, as described above, shown one example of the application of the charge pump circuit 30.

The charge pump circuit 30 typically includes a plurality of parallel arranged transistor-capacitor units generally shown at 32. Each unit 32 has a bipolar junction transistor 34 with a collector terminal connected to a base terminal and an emitter terminal connected to a capacitor 36.

The charge pump circuit 30 also includes drive circuitry 38 for driving the transistor-capacitor units 32 at a predetermined rate. Also included is load current circuitry 40 connected to a last transistor-capacitor unit, as shown. The load current circuitry 40 is configured to determine a load current through the transistor-capacitor units 32 in order to establish a controllable voltage drop across the transistor-capacitor units 32.

The charge pump 30 also includes supply circuitry 46 configured to supply the transistor-capacitor units 32 and the drive circuitry 38, as shown, The supply circuitry 46 is configured to bias a base-emitter voltage of the transistor-capacitor units 32 proportional to the load current through the charge pump, so that an output voltage Vₒᵤₜ of the charge pump 30 is substantially independent of temperature fluctuations.

The charge pump circuit 30 makes use of bipolar junction transistors 34 (BJT). The bipolar junction transistors 34 do generally not exhibit a body effect inherent to MOS devices. A base-emitter voltage V_{be} of each BJT is independent of the potential of the collector and emitter. In addition, the BJT shows a much smaller and uniform variation in V_{be} compared to a gate-source threshold voltage Vₜₕ of a MOSFET device. This is especially true for a charge pump having a large number of stages N. V_{be} is also a logarithmic function of a doping level in a PN junction of each BJT, making degradation of V_{be} with respect to any doping variation much less severe in comparison with Vₜₕ of a MOS device.

BJTs are generally available in a CMOS process as lateral or vertical devices. In the present example, no special demand is placed on a current gain factor beta, or the collector or base resistances, of the BJTs.

The load current circuitry 40 can be a current source which is a low-level high voltage current circuit configured to sink a finite current, e.g. 2-10 nA, from the charge pump 30. At such a level, the load current circuitry 40 does not impose a severe loading on the charge pump 30, but can improve the stability of the charge pump 30 by overriding the leakage current of the respective collector and drain-source PN junctions through the units 32 of the charge pump circuit 30.

The load current circuitry 40 is generally used to override any leakage current through the units 32, which is highly dependent on the temperature of the charge pump circuit 30. One example is configured so that load current circuitry 40 establishes a compensating load current I_{load} that is about one order of magnitude larger than the largest current observed in the capacitive sensor 10. Such a load current I_{load} can typically range from 1 nA to 10 nA. The addition of the load current I_{load} has the effect that the leakage current becomes insignificant and the voltage drop V_{be} over the BJTs becomes relatively constant.

The load current I_{load} can also be made proportional to the actual load current of the capacitive sensor. This would mitigate any effect of the loading on the value and noise of the voltage generated.

One additional benefit of establishing the load current I_{load} is that it facilitates the charge pump circuit 30 in coming to a stable V_{be} faster, as the impedance of the device is reduced by the load current according to the equation:

R_{eq}=1/gm=VT/I_{load}

Supply circuitry 46 is typically a BJT base-emitter voltage V_{be} voltage drop compensation supply voltage circuit. Supply circuitry 46 supplies a voltage which is a sum of V_{be} and a temperature stable constant voltage to the two phase clock of the drive circuitry 38. By biasing V_{be} at a certain current proportional to a constant current of the load current circuitry 40 loading the charge pump 39, the temperature and voltage dependency of the charge pump output voltage Vₒᵤₜ can be eliminated to a first order of accuracy. The result is a charge pump circuit 30 with output voltage Vₒᵤₜ independent of manufacturing tolerances of the BJTs and a temperature of the circuit 30.

As shown above for the Dickson charge pump circuit, the output voltage of the Dickson charge pump circuit is:

Vₒᵤₜ=N(V_{dd}*C/(C+Cp)−Vₜₕ)+V_{dd}, which becomes:

Vₒᵤₜ=N(V_{dd}*C/(C+Cp)−V_{be})+V_{dd}

for BJT devices, where Vₒᵤₜ is dependent on the V_{be} voltage drop if V_{dd} was a constant voltage:

Vₒᵤₜ=N(V_{dd}*C/(C+Cp)−V_{be})+V_{be}

A solution to the above is by making the supply voltage V_{dd} equal to a sum of K*V_{be} and a constant voltage V_{const} which is independent of supply voltage V_{dd} so that:

V_{dd}=V_{be}*(C+Cp)/C+V_{const}

V_{dd}=K*V_{be}+V_{const}

K is an estimate of (C+Cp)/C which can be estimated from the physical dimension of the integrated capacitors, transistors and interconnects.

The output voltage of the charge pump circuit 30 becomes:

Vₒᵤₜ=N(V_{dd}*C/(C+Cp)−V_{be})+V_{dd}

Vₒᵤₜ=(N+1)V_{const}+K*V_{be}

From this equation we see that the output voltage Vₒᵤₜ is reasonably independent of V_{be}. It is no longer multiplied by the number of stages N.

By using BJTs in which the base to emitter voltage V_{be} is independent of the potentials of the collector and emitter, the output voltage of the charge pump circuit is:

Vₒᵤₜ=N(V_{dd}−V_{be})+V_{dd}=(N+1)V_{const}+V_{be}

V_{be} is related to its current I_{load} by the equation:

V_{be}=V_{T} log(I_{load}/Iₛ)

Where V_{T} is the thermal voltage=kT/q and Iₛ is a constant for the bipolar transistor. The logarithmic variation of a bipolar transistor is much lower compared to a MOS transistor which has a square root dependency on the load current.

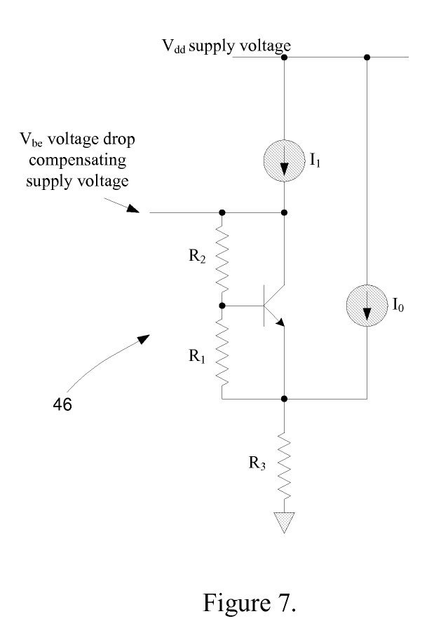

An example of the supply circuitry 46 for generating the above voltage is shown in FIG. 7. A current source I₁ supplies a constant current to a diode voltage multiplier with ratio of resistors R1 and R2 matched to 1+Cp/C, so that 1+R2/R1=1+Cp/C.

I₁ can be made to track the load current in the charge pump I_{load}. The resistor R3 is a resistor for generating the constant voltage with the additional current source I₀:

V_{const}=I₀*R3

The charge pump circuit 30 also includes a controlled impedance circuit 32, a shown, to filter out any switching noise in the output from the charge pump circuit 30.

Persons skilled in the art will appreciate that numerous variations and modifications will become apparent. All such variations and modifications which become apparent to persons skilled in the art should be considered to fall within the spirit and scope of the invention broadly appearing and described in more detail herein.

It is to be appreciated that reference to “one example” or “an example” of the invention is not made in an exclusive sense. Accordingly, one example may exemplify certain aspects of the invention, whilst other aspects are exemplified in a different example. These examples are intended to assist the skilled person in performing the invention and are not intended to limit the overall scope of the invention in any way unless the context clearly indicates otherwise.

Features that are common to the art are not explained in any detail as they are deemed to be easily understood by the skilled person. Similarly, throughout this specification, the term “comprising” and its grammatical equivalents shall be taken to have an inclusive meaning, unless the context of use clearly indicates otherwise.

1. A charge pump circuit for biasing a capacitive transducer, said circuit comprising:
a plurality of parallel arranged transistor-capacitor units each having a bipolar junction transistor with a collector terminal connected to a base terminal and an emitter terminal connected to a capacitor;
drive circuitry for driving the transistor-capacitor units at a predetermined rate;
load current circuitry connected to a last transistor-capacitor unit and configured to determine a load current through the transistor-capacitor units in order to establish a controllable voltage drop across the transistor-capacitor units; and
supply circuitry configured to supply the transistor-capacitor units and drive circuitry, the supply circuitry configured to bias a base-emitter voltage of the transistor-capacitor units proportional to the load current so that an output voltage of the charge pump is substantially independent of temperature fluctuations.

2. The charge pump circuit of claim 1, having a controlled impedance circuit connected to an output of the charge pump and configured to filter out switching noise of the drive circuitry.

3. The charge pump circuit of claim 1, wherein the load current circuitry is configured to override a leakage current of the transistor-capacitor units.

4. The charge pump circuit of claim 1, wherein the supply circuitry is configured to supply a voltage which is a sum of a base-emitter voltage V_{be} of each unit and a temperature stable constant voltage to the drive circuitry.

5. The charge pump circuit of claim 1, wherein the drive circuitry includes buffer circuitry for buffering a clock signal determining the predetermined rate.
